(19) United States
(12) Patent Application Publication
(10) Pub. No.: US 2024/0306271 A1
(43) Pub. Date: Sep. 12, 2024

(54) HEATING COOKING APPARATUS

(71) Applicant: SHARP KABUSHIKI KAISHA, Sakai City, Osaka (JP)

(72) Inventors: SHINJI ASAMI, Sakai City, Osaka (JP); MASAHIRO NISHIJIMA, Sakai City, Osaka (JP)

(21) Appl. No.: 18/276,064

(22) PCT Filed: Feb. 21, 2022
(86) PCT No.: PCT/JP2022/006928

§ 371 Date: Aug. 7, 2023

(30) Foreign Application Priority Data
Feb. 26, 2021 (JP) 2021-030098

(51) Int. Cl. H05B 6/64

(52) U.S. Cl. CPC H05B 6/6444; H05B 6/6414

(57) ABSTRACT

A heating cooking apparatus includes a heating cooking chamber, a first recessed portion, and a first light source unit. The heating cooking chamber includes an opening portion opening in a predetermined direction, a back wall disposed in a direction opposite to the predetermined direction with respect to the opening portion, and a plurality of walls extending from the back wall in the predetermined direction. The first recessed portion is located in a first wall of the plurality of walls and recessed from the first wall. The first recessed portion includes a first inclined wall inclined with respect to the first wall. The first light source unit is disposed on the first inclined wall. The first light source unit emits light toward the back wall of the heating cooking chamber.

### TECHNICAL FIELD

The present invention relates to a heating cooking apparatus.

### BACKGROUND ART

PTL 1 discloses a heating cooking device. The heating cooking device disclosed in PTL 1 includes a heating chamber and a light source. The heating chamber accommodates an object to be heated. The light source is disposed on a ceiling portion of the heating chamber. The light source emits light in the heating chamber.

### CITATION LIST

### Patent Literature

PTL 1: JP 2017-129295 A

### SUMMARY OF INVENTION

### Technical Problem

However, in the heating cooking device disclosed in PTL 1, the light source emits light in a direction orthogonal to the ceiling. Thus, the inside of a heating cooking chamber such as a heating chamber or an object to be heated that is accommodated in the heating cooking chamber cannot be observed in detail from an opening portion side of the heating cooking device.

In light of the above problem, an object of the present invention is to provide a heating cooking apparatus that allows detailed observation of the inside of a heating cooking chamber or an object to be heated that is accommodated in the heating cooking chamber.

### Solution to Problem

According to an aspect of the present invention, a heating cooking apparatus includes a heating cooking chamber, a first recessed portion, and a first light source unit. The heating cooking chamber includes an opening portion opening in a predetermined direction, a back wall disposed in a direction opposite to the predetermined direction with respect to the opening portion, and a plurality of walls extending from the back wall in the predetermined direction. The first recessed portion is located in a first wall of the plurality of walls and recessed from the first wall. The first recessed portion includes a first inclined wall inclined with respect to the first wall. The first light source unit is disposed on the first inclined wall. The first light source unit emits light toward the back wall of the heating cooking chamber.

### Advantageous Effects of Invention

The heating cooking apparatus of the present invention allows detailed observation of the inside of the heating cooking chamber or an object to be heated that is accommodated in the heating cooking chamber.

### BRIEF DESCRIPTION OF DRAWINGS

FIG. 1 is a perspective view illustrating a pull-out type heating cooking apparatus according to an embodiment of the present invention.

FIG. 2 is a right side view illustrating the pull-out type heating cooking apparatus according to the present embodiment.

FIG. 3 is a top view illustrating the pull-out type heating cooking apparatus according to the present embodiment.

FIG. 4 is an exploded perspective view illustrating a pull-out body according to the present embodiment.

FIG. 5 is a right side view illustrating the pull-out type heating cooking apparatus according to the present embodiment.

FIG. 6 is a cross-sectional view illustrating the pull-out type heating cooking apparatus taken along section line VI in FIG. 5.

FIG. 7 is an enlarged cross-sectional view illustrating the pull-out type heating cooking apparatus of FIG. 6.

FIG. 8 is a perspective view illustrating a first light source unit according to the present embodiment.

FIG. 9 is an exploded perspective view illustrating the first light source unit according to the present embodiment.

FIG. 10 is a block diagram illustrating a configuration of the pull-out type heating cooking apparatus according to the present embodiment.

FIG. 11 is a perspective view illustrating an appearance of a cabinet to which the pull-out type heating cooking apparatus according to the present embodiment is attached.

### DESCRIPTION OF EMBODIMENTS

Hereinafter, embodiments of a pull-out type heating cooking apparatus according to the present invention will be described with reference to the drawings. Note that, in the drawings, the same or equivalent components are denoted by the same reference signs, and description thereof will not be repeated.

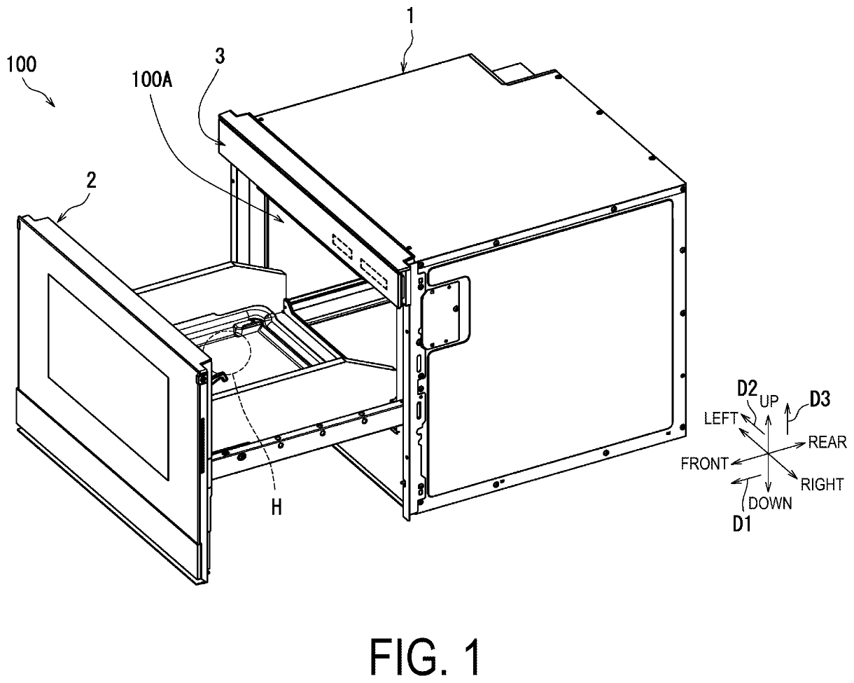

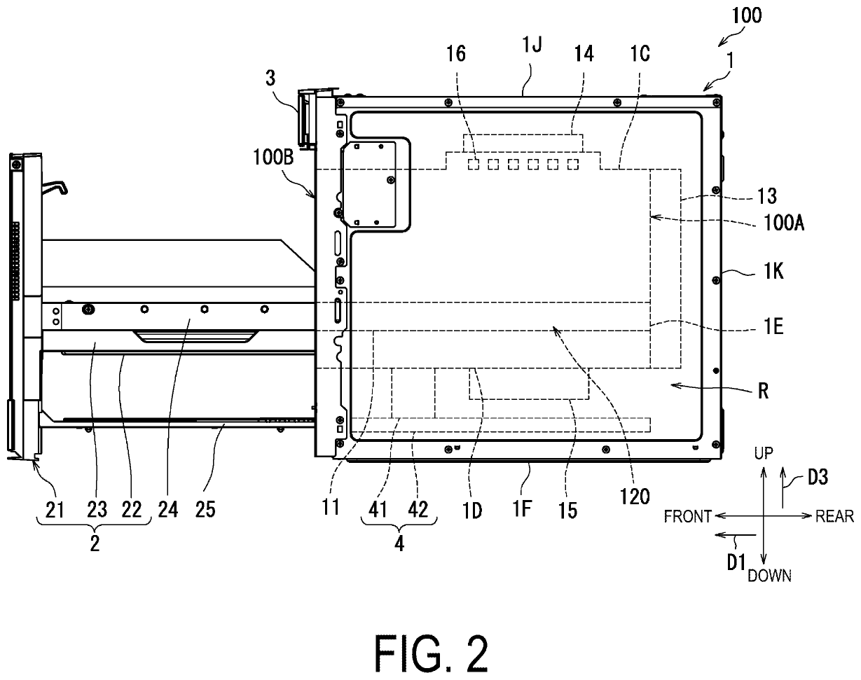

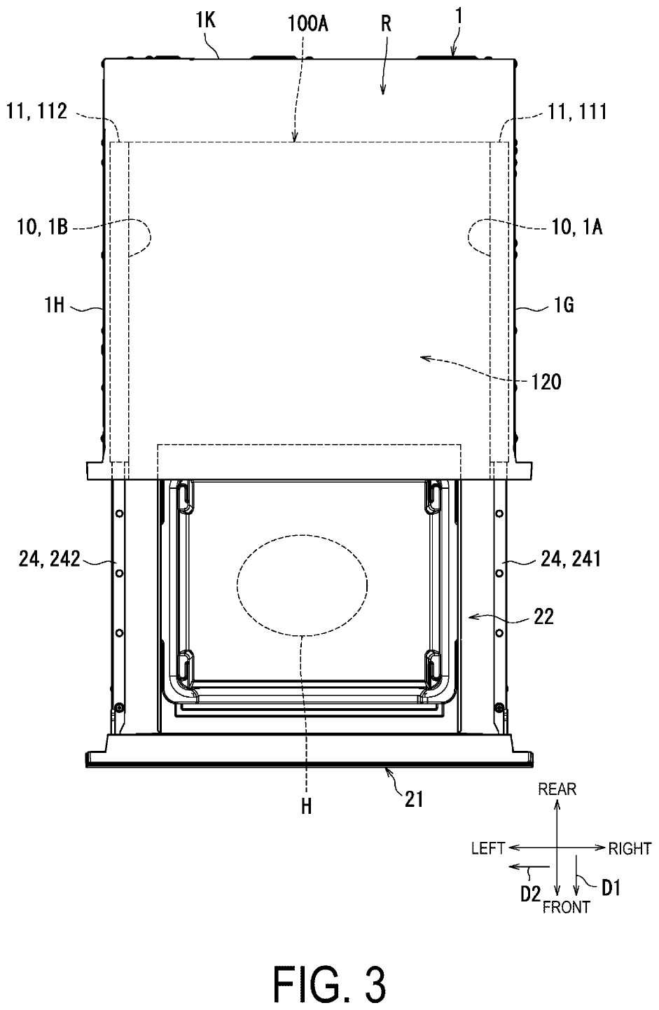

A pull-out type heating cooking apparatus 100 will be described with reference to FIG. 1 to FIG. 3. FIG. 1 is a perspective view illustrating the pull-out type heating cooking apparatus 100. FIG. 2 is a right side view illustrating the pull-out type heating cooking apparatus 100. FIG. 3 is a top view illustrating the pull-out type heating cooking apparatus 100. More specifically, FIG. 1 to FIG. 3 illustrate the pull-out type heating cooking apparatus 100 in a state where a pull-out body 2 is pulled out. Further, FIG. 1 illustrates an external appearance of the pull-out type heating cooking apparatus 100 as viewed diagonally from the upper front right. The pull-out type heating cooking apparatus 100 is an example of “heating cooking apparatus”.

As illustrated in FIG. 1, the pull-out type heating cooking apparatus 100 heats and cooks an object H to be heated. The object H to be heated is, for example, a foodstuff. The pull-out type heating cooking apparatus 100 includes a heating chamber 1, the pull-out body 2, an operation panel 3, and a heating cooking chamber 100A.

In the present embodiment, a side on which the operation panel 3 of the pull-out type heating cooking apparatus 100 is disposed is defined as a front side of the pull-out type heating cooking apparatus 100, and a side opposite to the front side (rear face side) is defined as a rear side of the pull-out type heating cooking apparatus 100. Further, a right side when the pull-out type heating cooking apparatus 100 is viewed from the front side is defined as a right side of the pull-out type heating cooking apparatus 100, and a side opposite to the right side is defined as a left side of the pull-out type heating cooking apparatus 100. Further, in a direction orthogonal to a front-rear direction and a left-right direction of the pull-out type heating cooking apparatus 100, a side on which the operation panel 3 is disposed is defined as an upper side of the pull-out type heating cooking apparatus 100, and a side opposite to the upper side (bottom side) is defined as a lower side of the pull-out type heating cooking apparatus 100. Note that these orientations do not limit an orientation of the pull-out type heating cooking apparatus 100 in use.

As illustrated in FIG. 1 to FIG. 3, the heating chamber 1 is a box-like member. Specifically, the heating chamber 1 includes a right outer wall 1G, a left outer wall 1H, a top outer wall 1J, a bottom outer wall 1F, and a back outer wall 1K. The heating chamber 1 accommodates the heating cooking chamber 100A.

The pull-out body 2, on which the object H to be heated is placed, can be pulled out in a first direction D1 from the heating cooking chamber 100A. The first direction D1 is an example of “predetermined direction”. The first direction D1 is the forward direction. A third direction D3 intersects the first direction D1. In the present embodiment, the third direction D3 is orthogonal to the first direction D1. In the present embodiment, the third direction D3 is an upward direction (direction opposite to a vertical direction). Specifically, the pull-out body 2 includes a lid portion 21, a placing portion 22, and a support portion 23.

The heating cooking chamber 100A includes an accommodation space 120 that accommodates the object H to be heated. The shape of the heating cooking chamber 100A is, for example, a substantially rectangular parallelepiped shape. Specifically, the heating cooking chamber 100A includes a pair of side wall portions 10, a back wall 1E, and an opening portion 100B. The pair of side wall portions 10 correspond to an example of “a plurality of walls”. The opening portion 100B opens in the first direction D1. The opening portion 100B communicates with the outside of the heating cooking chamber 100A. The back wall 1E is disposed in a direction opposite to the first direction D1 with respect to the opening portion 100B. That is, the opening portion 100B faces the back wall 1E.

The pair of side wall portions 10 extend from the back wall 1E in the first direction D1. Moreover, the pair of side wall portions 10 face each other in a second direction D2. The second direction D2 is the left direction. Specifically, the pair of side wall portions 10 include a right wall 1A and a left wall 1B. The right wall 1A corresponds to an example of “first wall”. The left wall 1B corresponds to an example of “second wall”. The heating cooking chamber 100A further includes a top wall 1C and a bottom wall 1D. Materials of the right wall 1A, the left wall 1B, the top wall 1C, the bottom wall 1D, and the back wall 1E are, for example, a metal.

The heating chamber 1 further includes a space R between the heating chamber 1 and the heating cooking chamber 100A. Specifically, the heating chamber 1 further includes the space R between the bottom wall 1D and the bottom outer wall 1F. The heating chamber 1 further includes the space R between the right wall 1A and the right outer wall 1G. The heating chamber 1 further includes the space R between the left wall 1B and the left outer wall 1H. The heating chamber 1 further includes the space R between the top wall 1C and the top outer wall 1J. The heating chamber 1 further includes the space R between the back wall 1E and the back outer wall 1K.

As illustrated in FIG. 3, the pull-out type heating cooking apparatus 100 further includes a pair of rail members 11. Specifically, one rail member of the pair of rail members 11 includes a right side rail member 111, and the other rail member of the pair of rail members 11 includes a left side rail member 112. The right side rail member 111 and the left side rail member 112 face each other in the second direction D2.

Each of the right side rail member 111 and the left side rail member 112 is disposed in the heating chamber 1. Specifically, each of the right side rail member 111 and the left side rail member 112 is disposed between the heating chamber 1 and the heating cooking chamber 100A. More specifically, the right side rail member 111 is fixed to the right wall 1A in the space R between the right wall 1A and the right outer wall 1G. The left side rail member 112 is fixed to the left wall 1B in the space R between the left wall 1B and the left outer wall 1H. In particular, each of the right side rail member 111 and the left side rail member 112 extends in the first direction D1.

Meanwhile, the pull-out type heating cooking apparatus 100 further includes a pair of slide members 24. Specifically, one slide member of the pair of slide members 24 includes a right side slide member 241, and the other slide member of the pair of slide members 24 includes a left side slide member 242. The right side slide member 241 and the left side slide member 242 face each other in the second direction D2.

Each of the right side slide member 241 and the left side slide member 242 is disposed on the lid portion 21. Specifically, one end portion of the right side slide member 241 is attached to a right edge portion of the lid portion 21. One end portion of the left side slide member 242 is attached to a left edge portion of the lid portion 21. In particular, each of the right side slide member 241 and the left side slide member 242 extends in a direction opposite to the first direction D1 from the lid portion 21.

The right side slide member 241 is slidably supported by the right side rail member 111. The left side slide member 242 is slidably supported by the left side rail member 112.

As illustrated in FIG. 2, the pull-out type heating cooking apparatus 100 further includes a support member 25. The support member 25 supports the lid portion 21. One end portion of the support member 25 is attached at a center portion of the lid portion 21 in the left-right direction and below the placing portion 22. The support member 25 is a plate-like member extending in the direction opposite to the first direction D1 from the lid portion 21. The support member 25 includes a rack portion. The rack portion includes teeth. The support member 25 may be a single plate-like member or a plurality of plate-like members.

Meanwhile, the pull-out type heating cooking apparatus 100 further includes a drive mechanism 4. The drive mechanism 4 drives the support member 25. The drive mechanism 4 is positioned below the heating cooking chamber 100A. Specifically, the drive mechanism 4 is accommodated in the space R between the bottom wall 1D and the bottom outer wall 1F. For example, the drive mechanism 4 includes a drive motor 41, a pinion, and a drive rail 42. The drive rail 42 is fixed in the space R between the bottom wall 1D and the bottom outer wall 1F. The drive rail 42 is a member whose longitudinal direction is the first direction D1. The support member 25 is slidably supported by the drive rail 42. The drive motor 41 rotates the pinion.

The pinion engages with the rack portion of the support member 25. Furthermore, the support member 25 moves in the first direction D1 as a result of rotation of the pinion. Note that the drive mechanism 4 may drive at least one of the support member 25, and the right side slide member 241 and the left side slide member 242. Furthermore, in a case where the right side slide member 241 and the left side slide member 242 are driven, the drive mechanism 4 may be positioned more on the side than the heating cooking chamber 100A.

As illustrated in FIG. 1, the operation panel 3 receives an operation from a user. The operation includes, for example, a cooking method for heating and cooking the object H to be heated, or information about movement of the lid portion 21 between the closed position and the open position thereof. Specifically, the operation panel 3 includes a display unit, a storage unit, and a control unit. The display unit displays various pieces of information. Specifically, the display unit includes a liquid crystal panel.

As illustrated in FIG. 2, the pull-out type heating cooking apparatus 100 further includes a first air sending unit 14, a second air sending unit 13, a grill unit 16, and a microwave supply unit 15. The first air sending unit 14 circulates air between the inside of the heating cooking chamber 100A and the first air sending unit 14. The second air sending unit 13 circulates air between the inside of the heating cooking chamber 100A and the second air sending unit 13. The grill unit 16 heats and cooks the object H to be heated by conducting heat generated by a heater to the object H to be heated. The microwave supply unit 15 supplies microwaves into the heating cooking chamber 100A.

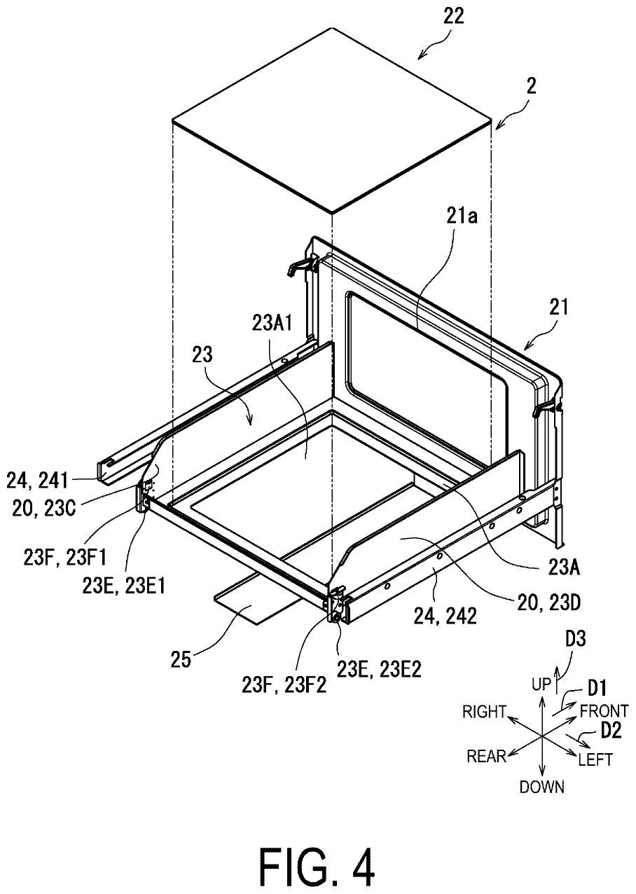

Next, the pull-out body 2 will be described in detail with reference to FIG. 4. FIG. 4 is an exploded perspective view illustrating the pull-out body 2 according to the present embodiment. As illustrated in FIG. 4, the object H to be heated can be placed on the placing portion 22. Specifically, the placing portion 22 includes a placing surface on which the object H to be heated is placed. The material of the placing portion 22 is a non-metal, and is preferably ceramic or glass, for example.

The support portion 23 is attached to the lid portion 21 and supports a peripheral edge portion of the placing portion 22 such that the placing portion 22 is held in a horizontal state. Specifically, the support portion 23 includes a bottom plate portion 23A and a pair of wall portions 20. The material of the support portion 23 is, for example, a metal.

The bottom plate portion 23A includes a rectangular opening portion 23A1. The rectangular opening portion 23A1 is located at substantially a center portion of the bottom plate portion 23A.

One wall portion of the pair of wall portions 20 includes a right side plate portion 23C, and the other wall portion of the pair of wall portions 20 includes a left side plate portion 23D. Each of the right side plate portion 23C and the left side plate portion 23D extends in substantially the first direction D1. The right side plate portion 23C and the left side plate portion 23D face each other in substantially the second direction D2. More specifically, the right side plate portion 23C and the left side plate portion 23D extend upward from the peripheral edge portion of the bottom plate portion 23A. The placing portion 22 is fitted among the lid portion 21, the right side plate portion 23C, and the left side plate portion 23D. The peripheral edge portion of the placing portion 22 is fixed to an upper surface of the peripheral edge portion of the bottom plate portion 23A.

The support portion 23 further includes a pair of rollers 23E and a pair of rollers 23F. The pair of rollers 23E and the pair of rollers 23F rotate as the pull-out body 2 moves. Specifically, one roller of the pair of rollers 23E includes a right side roller 23E1, and the other roller of the pair of rollers 23E includes a left side roller 23E2. The right side roller 23E1 and the left side roller 23E2 rotate about a rotation axis along substantially the second direction D2. In addition, the right side roller 23E1 is attached to a rear end portion of the right side plate portion 23C (on a side in a direction opposite to substantially the first direction D1). The left side roller 23E2 is attached to a rear end portion of the left side plate portion 23D. The right side roller 23E1 and the left side roller 23E2 are in contact with the bottom wall 1D.

Also, one roller of the pair of rollers 23F includes a right side roller 23F1, and the other roller of the pair of rollers 23F includes a left side roller 23F2. The right side roller 23F1 and the left side roller 23F2 rotate about a rotation axis along substantially the third direction D3. The right side roller 23F1 is attached to the rear end portion of the right side plate portion 23C. The left side roller 23F2 is attached to the rear end portion of the left side plate portion 23D. The right side roller 23F1 is in contact with the right wall 1A. The left side roller 23F2 is in contact with the left wall 1B.

The placing portion 22 and the support portion 23 are accommodated in the heating cooking chamber 100A when the lid portion 21 is located at the closed position. The lid portion 21 includes a window portion 21a. As a result, even when the lid portion 21 is located at the closed position, the object H to be heated can be visually recognized. On the other hand, when the lid portion 21 is located at the open position, the placing portion 22 and the support portion 23 are pulled out from the inside of the heating cooking chamber 100A in a state where the pair of rollers 23E and the pair of rollers 23F are accommodated in the heating cooking chamber 100A.

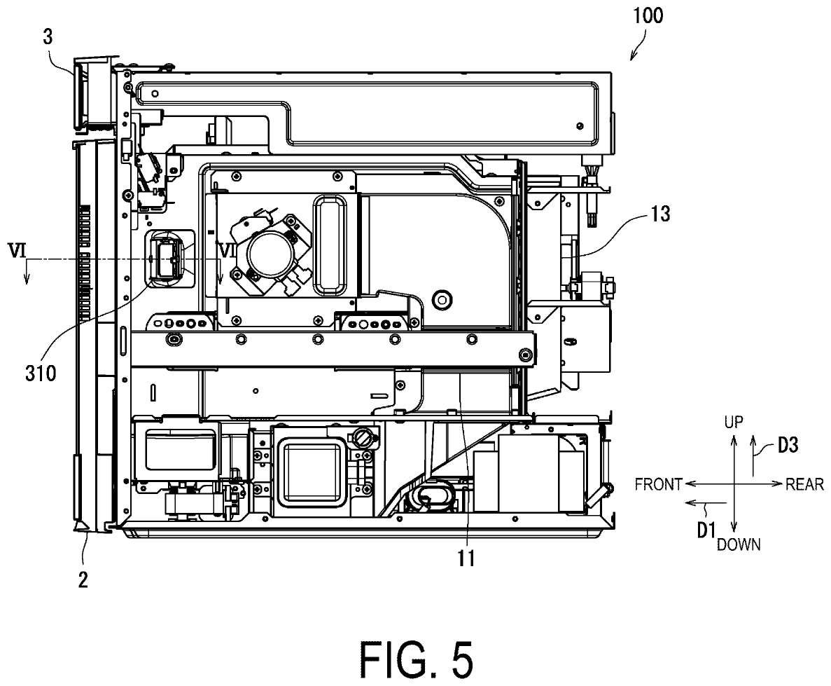

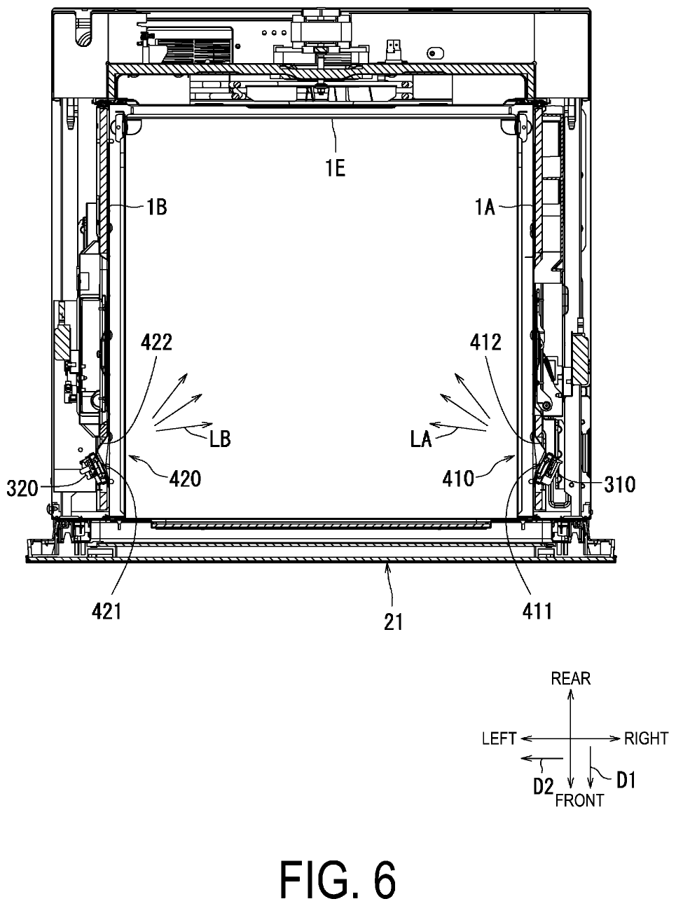

Next, the pull-out type heating cooking apparatus 100 will be described in detail with reference to FIG. 5 and FIG. 6. FIG. 5 is a right side view illustrating the pull-out type heating cooking apparatus 100. FIG. 6 is a cross-sectional view illustrating the pull-out type heating cooking apparatus 100 taken along section line VI in FIG. 5. In detail, FIG. 5 illustrates the pull-out type heating cooking apparatus 100 from which the right outer wall 1G, the left outer wall 1H, the top outer wall 1J, the bottom outer wall 1F, and the back outer wall 1K are removed.

As illustrated in FIG. 5 and FIG. 6, the pull-out type heating cooking apparatus 100 further includes a first recessed portion 410 and a first light source unit 310.

The first recessed portion 410 is located in the right wall 1A. The first recessed portion 410 is recessed from the right wall 1A. Specifically, the first recessed portion 410 is recessed from the right wall 1A in a direction opposite to the second direction D2.

The first light source unit 310 emits light LA in a direction opposite to the first direction D1 in the heating cooking chamber 100A. In other words, the first light source unit 310 emits the light LA toward the back wall 1E of the heating cooking chamber 100A. The first light source unit 310 also emits the light LA toward the left wall 1B of the heating cooking chamber 100A.

As described above, since the first light source unit 310 emits the light LA in a direction opposite to the first direction D1 in the heating cooking chamber 100A, the inside of the heating cooking chamber 100A or the object H to be heated that is accommodated in the heating cooking chamber 100A is irradiated with the light LA. As a result, the inside of the heating cooking chamber 100A or the object H to be heated that is accommodated in the heating cooking chamber 100A can be observed in detail.

In more detail, the first recessed portion 410 is located on an upper side of the right wall 1A. Specifically, the first recessed portion 410 is located above an upper end of the right side plate portion 23C. The first recessed portion 410 is located on a front side of the right wall 1A. As a result, the inside of the heating cooking chamber 100A or the object H to be heated that is accommodated in the heating cooking chamber 100A can be observed in more detail.

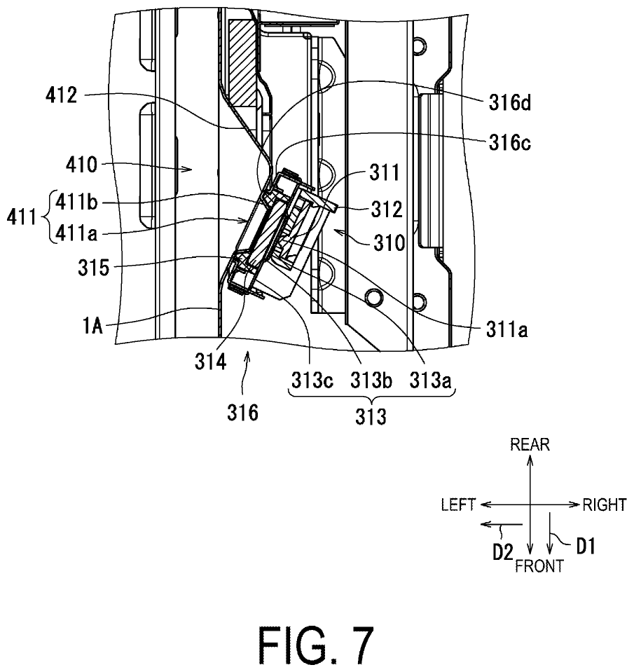

Next, the pull-out type heating cooking apparatus 100 will be described in detail with reference to FIG. 6 and FIG. 7. FIG. 7 is an enlarged cross-sectional view illustrating the pull-out type heating cooking apparatus 100 of FIG. 6. As illustrated in FIG. 6 and FIG. 7, the first recessed portion 410 includes a first inclined wall 411 and a third inclined wall 412.

Each of the first inclined wall 411 and the third inclined wall 412 is inclined with respect to the right wall 1A. Specifically, the first inclined wall 411 faces the back wall 1E. The third inclined wall 412 faces the opening portion 100B.

In detail, the side of the third inclined wall 412 in a direction opposite to the first direction D1 is coupled to the right wall 1A. The third inclined wall 412 extends in a direction opposite to the second direction D2 as the third inclined wall 412 extends in the first direction D1. On the other hand, the side of the first inclined wall 411 in the first direction D1 is coupled to the right wall 1A. The first inclined wall 411 extends in a direction opposite to the second direction D2 as the first inclined wall 411 extends in a direction opposite to the first direction D1. The side of the third inclined wall 412 in the first direction D1 and the side of the first inclined wall 411 in a direction opposite to the first direction D1 are coupled.

The first light source unit 310 is disposed on the first inclined wall 411. The first light source unit 310 emits the light LA toward the back wall 1E of the heating cooking chamber 100A. In detail, the first light source unit 310 emits the expanded light beam LA. For example, the cross-sectional shape of the expanded light beam LA is substantially circular in a plane perpendicular to the traveling direction of the expanded light beam LA. In addition, the cross-sectional dimensions of the expanded light beam LA in the plane perpendicular to the traveling direction of the expanded light beam LA increase as the expanded light beam LA travels in the traveling direction.

As described above, since the first light source unit 310 emits the light LA toward the back wall 1E of the heating cooking chamber 100A, the back wall 1E of the heating cooking chamber 100A is irradiated with the light LA. As a result, the back wall 1E of the heating cooking chamber 100A can be observed in detail.

In detail, the first inclined wall 411 includes a communication hole 411a and a tubular portion 411b. The inside and the outside of the heating cooking chamber 100A communicate with each other through the communication hole 411a. Specifically, the communication hole 411a has a circular shape.

The tubular portion 411b extends from the communication hole 411a toward the outside of the heating cooking chamber 100A. Specifically, the tubular portion 411b has a truncated conical shape. Further, the tubular portion 411b becomes smaller as the tubular portion 411b extends toward the outside of the heating cooking chamber 100A.

The first light source unit 310 is disposed outside the heating cooking chamber 100A and faces the tubular portion 411b. As a result, the distance between the first light source unit 310 and the back wall 1E increases. Thus, the cross-sectional dimensions of the expanded light beam LA in the heating cooking chamber 100A can be increased. As a result, a wide range of the back wall 1E of the heating cooking chamber 100A or the object H to be heated that is accommodated in the heating cooking chamber 100A can be observed in detail. Moreover, forming the tubular portion 411b into a truncated conical shape can suppress leakage of microwaves to the outside of the heating cooking chamber 100A.

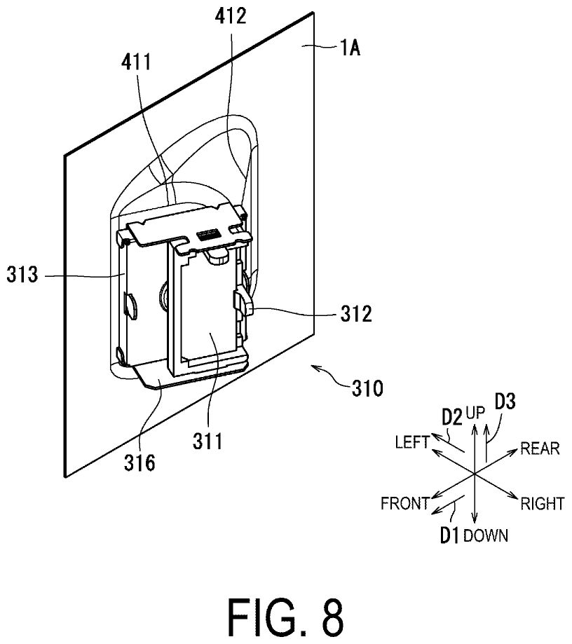

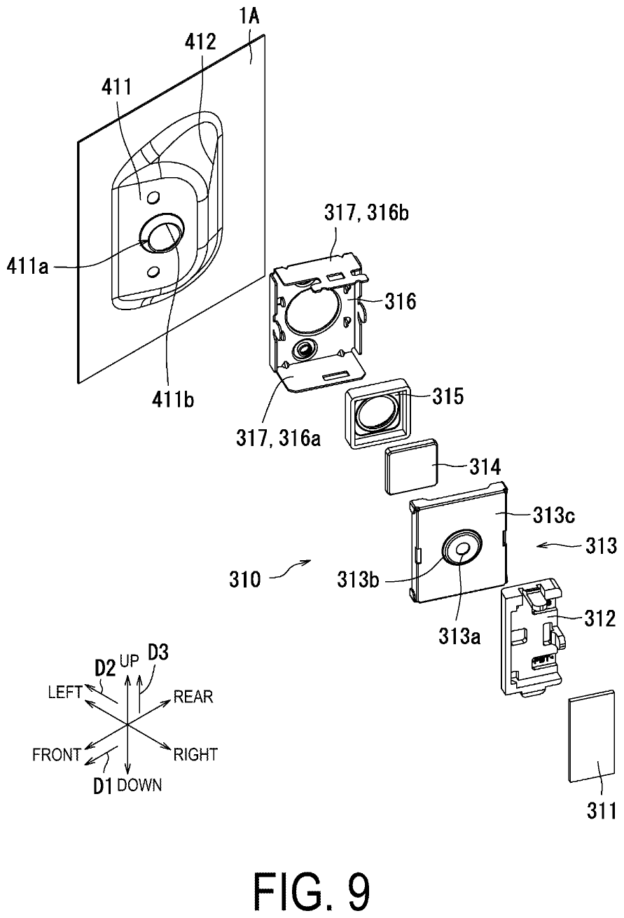

Next, the first light source unit 310 will be described in detail with reference to FIG. 8 and FIG. 9. FIG. 8 is a perspective view illustrating the first light source unit 310. FIG. 9 is an exploded perspective view illustrating the first light source unit 310. As illustrated in FIG. 8 and FIG. 9, the first light source unit 310 includes a light source substrate 311, a glass plate 314, and an attachment member 316.

The attachment member 316 has a thermal conductivity lower than the thermal conductivity of the first inclined wall 411. The material of the attachment member 316 is, for example, a metal having a thermal conductivity lower than the thermal conductivity of the first inclined wall 411. Specifically, the attachment member 316 includes a plurality of wall portions 317 made of a metal and a third metal plate 316c. The third metal plate 316c is disposed between the plurality of wall portions 317. In detail, the plurality of wall portions 317 include a first metal plate 316a and a second metal plate 316b. The first metal plate 316a and the second metal plate 316b face each other. The third metal plate 316c is disposed between the first metal plate 316a and the second metal plate 316b. The third metal plate 316c is orthogonal to each of the first metal plate 316a and the second metal plate 316b. The third metal plate 316c includes a circular through hole 316d. The third metal plate 316c is attached to the first inclined wall 411 with a screw or the like. The tubular portion 411b passes through the through hole 316d.

The light source substrate 311 further includes, for example, a light emitting diode (LED) 311a. The LED 311a corresponds to an example of “light source”. The light source substrate 311 is attached to the first inclined wall 411 via the attachment member 316. Specifically, the light source substrate 311 is attached to the first metal plate 316a and the second metal plate 316b.

The light LA passes through the glass plate 314. Specifically, the glass plate 314 has a rectangular parallelepiped shape. The glass plate 314 is disposed between the tubular portion 411b and the light source substrate 311.

As described above, since the light source substrate 311 is attached to the first inclined wall 411 via the attachment member 316, it is possible to suppress heat transfer from the first inclined wall 411 to the light source substrate 311. As a result, it is possible to suppress breakage of the light source substrate 311 by heat.

In more detail, the first light source unit 310 further includes a case 312, a metal member 313, and a packing 315.

The packing 315 is disposed on the outer periphery of the glass plate 314. The material of the packing 315 is, for example, rubber. As a result, the glass plate 314 and the tubular portion 411b can be fixed to each other.

The metal member 313 includes a communication hole 313a, a tubular portion 313b, and a metal plate 313c. The material of the metal member 313 is, for example, a metal having a thermal conductivity lower than the thermal conductivity of the first inclined wall 411. The communication hole 313a is located in the metal plate 313c. The inside and the outside of the heating cooking chamber 100A communicate with each other through the communication hole 313a. Specifically, the communication hole 313a has a circular shape. The size of the communication hole 313a is smaller than the size of the communication hole 411a. The metal plate 313c faces the third metal plate 316c. As a result, the tubular portion 411b is surrounded by the metal member 313 and the attachment member 316 except for a portion corresponding to the communication hole 313a.

The tubular portion 313b extends from the communication hole 313a toward the outside of the heating cooking chamber 100A. Specifically, the tubular portion 313b has a truncated conical shape. Further, the tubular portion 313b becomes smaller as the tubular portion 313b extends toward the outside of the heating cooking chamber 100A. As a result, the distance between the light source substrate 311 and the back wall 1E increases. Thus, the cross-sectional dimensions of the expanded light beam LA in the heating cooking chamber 100A can be increased. As a result, a wide range of the back wall 1E of the heating cooking chamber 100A can be observed in more detail.

In addition, overlapping the metal member 313 with the attachment member 316 covers the opening portion of the communication hole 411a, and reducing the size of the communication hole 313a further suppresses leakage of microwaves to the outside of the heating cooking chamber 100A. In addition, the tubular portion 313b allows the light source substrate 311 and the glass plate 314 to be disposed apart from each other, and thus a heat insulating layer of air can be provided between the light source substrate 311 and the glass plate 314, which can further suppress heat conduction to the light source substrate 311.

The light source substrate 311 is attached to the case 312. Further, the case 312 is attached to the first metal plate 316a and the second metal plate 316b. The material of the case 312 is, for example, a synthetic resin. As a result, heat transfer from the first inclined wall 411 to the light source substrate 311 can be further suppressed. In addition, the light source substrate 311 can be rigidly fixed to the first metal plate 316a and the second metal plate 316b.

A second light source unit 320 will be described in detail with reference to FIG. 6 again. As illustrated in FIG. 6, the pull-out type heating cooking apparatus 100 further includes a second recessed portion 420 and the second light source unit 320.

The second recessed portion 420 is located in the left wall 1B. The second recessed portion 420 is recessed from the left wall 1B. Specifically, the second recessed portion 420 is recessed from the left wall 1B in the second direction D2.

The second light source unit 320 emits light LB in a direction opposite to the first direction D1 in the heating cooking chamber 100A. In other words, the second light source unit 320 emits the light LB toward the back wall 1E of the heating cooking chamber 100A. The second light source unit 320 also emits the light LB toward the right wall 1A of the heating cooking chamber 100A.

The second recessed portion 420 includes a second inclined wall 421 and a fourth inclined wall 422. Each of the second inclined wall 421 and the fourth inclined wall 422 is inclined with respect to the left wall 1B. Specifically, the second inclined wall 421 faces the back wall 1E. The fourth inclined wall 422 faces the opening portion 100B.

In detail, the side of the fourth inclined wall 422 in a direction opposite to the first direction D1 is coupled to the left wall 1B. The fourth inclined wall 422 extends in the second direction D2 as the fourth inclined wall extends in the first direction D1. On the other hand, the side of the second inclined wall 421 in the first direction D1 is coupled to the left wall 1B. The second inclined wall 421 extends in the second direction D2 as the second inclined wall 421 extends in a direction opposite to the first direction D1. The side of the fourth inclined wall 422 in the first direction D1 and the side of the second inclined wall 421 in a direction opposite to the first direction D1 are coupled.

The second light source unit 320 is disposed on the second inclined wall 421. The second light source unit 320 emits the light LB toward the back wall 1E of the heating cooking chamber 100A. In detail, the second light source unit 320 emits the expanded light beam LB. For example, the cross-sectional shape of the expanded light beam LB is substantially circular in a plane perpendicular to the traveling direction of the expanded light beam LB. Further, the cross-sectional dimensions of the expanded light beam LB in the plane perpendicular to the traveling direction of the expanded light beam LB increase as the expanded light beam LB travels in the traveling direction.

As described above, the first light source unit 310 emits the light LA from the right wall 1A in a direction opposite to the first direction D1 in the heating cooking chamber 100A, and the second light source unit 320 emits the light LB from the left wall 1B in a direction opposite to the first direction D1 in the heating cooking chamber 100A, so that the inside of the heating cooking chamber 100A or the object H to be heated that is accommodated in the heating cooking chamber 100A can be observed in more detail.

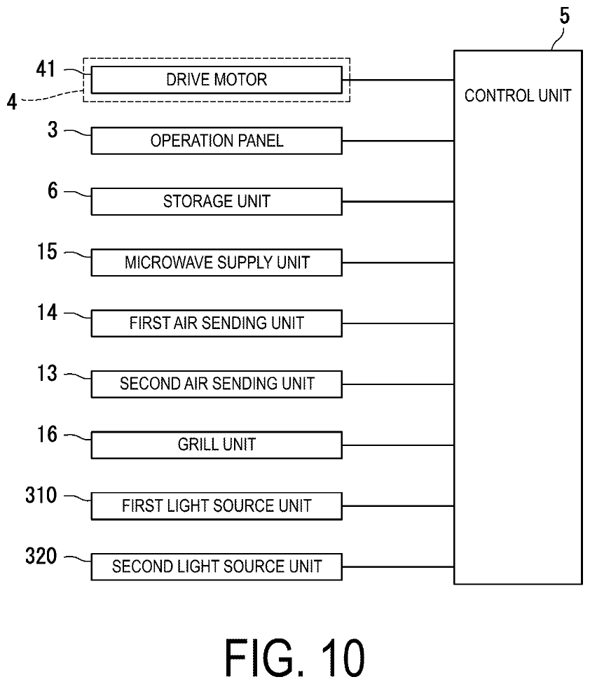

Next, the configuration of the pull-out type heating cooking apparatus 100 will be described in detail with reference to FIG. 10. FIG. 10 is a block diagram illustrating a configuration of the pull-out type heating cooking apparatus 100 according to the present embodiment.

As illustrated in FIG. 10, a control unit 5 controls the first air sending unit 14, the second air sending unit 13, the grill unit 16, the microwave supply unit 15, the first light source unit 310, the second light source unit 320, the drive motor 41, the operation panel 3, and a storage unit 6 by executing control programs stored in the storage unit 6.

Specifically, the control unit 5 controls the first light source unit 310 and the second light source unit 320 when the lid portion 21 is located at the open position. As a result, the inside of the heating cooking chamber 100A can be observed in detail. In addition, the control unit 5 controls the first light source unit 310 and the second light source unit 320 when the object H to be heated is heated and cooked. As a result, the object H to be heated that is accommodated in the heating cooking chamber 100A can be observed in detail.

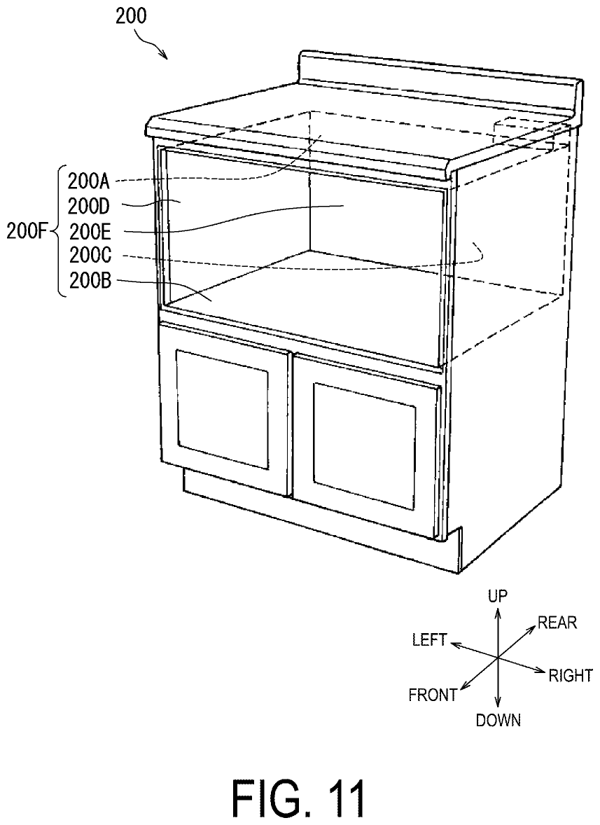

Subsequently, a cabinet 200 to which the pull-out type heating cooking apparatus 100 is attached will be described with reference to FIG. 11. FIG. 11 is a diagram illustrating an appearance of the cabinet 200 to which the pull-out type heating cooking apparatus 100 according to the present embodiment is attached.

The pull-out type heating cooking apparatus 100 is installed in the cabinet 200 in a built-in manner. As illustrated in FIG. 11, the cabinet 200 includes an upper wall 200A, a lower wall 200B, a right wall 200C, a left wall 200D, and a rear wall 200E. The upper wall 200A, the lower wall 200B, the right wall 200C, the left wall 200D, and the rear wall 200E form an accommodation portion 200F. The accommodation portion 200F is a rectangular parallelepiped space into which the pull-out type heating cooking apparatus 100 is fitted.

The embodiment of the present invention has been described above with reference to the accompanying drawings. However, the present invention is not limited to the embodiment described above, and the present invention can be implemented in various modes without departing from the gist thereof. The drawings primarily schematically illustrate each of the constituent elements for the sake of easier understanding, and the thickness, length, quantity, and the like of each of the illustrated constituent elements are different from the actual thickness, length, quantity, and the like by reason of creation of the drawings. Further, the material, shape, dimensions, and the like of each of the constituent elements illustrated in the embodiment described above are merely examples and are not particularly limited, and various modifications can be made within the scope not substantially departing from the effects of the present invention.

As described with reference to FIG. 1 to FIG. 11, the first recessed portion 410 is located in the right wall 1A and the first light source unit 310 is located on the right wall 1A, but the present invention is not limited thereto. The first recessed portion 410 may be located in the top wall 1C, the bottom wall 1D, or the left wall 1B and the first light source unit 310 may be located on the top wall 1C, the bottom wall 1D, or the left wall 1B.

### INDUSTRIAL APPLICABILITY

The present invention provides a heating cooking apparatus, and the provided heating cooking apparatus has industrial applicability.

### REFERENCE SIGNS LIST

1 Pull-out type heating cooking apparatus (heating cooking apparatus)
100A Heating cooking chamber
100B Opening portion
1A Right wall (first wall)
1B Left wall (second wall)
1E Back wall
310 First light source unit
320 Second light source unit
410 First recessed portion
411 First inclined wall
420 Second recessed portion
D1 First direction (predetermined direction)

1. A heating cooking apparatus comprising:
a heating cooking chamber including an opening portion opening in a predetermined direction, a back wall disposed in a direction opposite to the predetermined direction with respect to the opening portion, and a plurality of walls extending from the back wall in the predetermined direction;
a first recessed portion located in a first wall of the plurality of walls and recessed from the first wall; and
a first light source unit,
wherein the first recessed portion includes a first inclined wall inclined with respect to the first wall,
the first light source unit is disposed on the first inclined wall, and
the first light source unit emits light toward the back wall of the heating cooking chamber.

2. The heating cooking apparatus according to claim 1, further comprising
a microwave supply unit configured to supply a microwave into the heating cooking chamber,
wherein the first inclined wall includes
a communication hole through which an inside and an outside of the heating cooking chamber communicate with each other, and
a tubular portion extending from the communication hole toward the outside of the heating cooking chamber, and
the first light source unit is disposed outside the heating cooking chamber and faces the tubular portion.

3. The heating cooking apparatus according to claim 2,
wherein the first light source unit includes
a light source substrate including a light source,
a glass plate through which the light passes, and
an attachment member having a thermal conductivity lower than a thermal conductivity of the first inclined wall,
the glass plate is disposed between the tubular portion and the light source substrate, and
the light source substrate is attached to the first inclined wall via the attachment member.

4. The heating cooking apparatus according to claim 3,
wherein the first light source unit further includes a metal member,
the metal member includes
a communication hole through which the inside and the outside of the heating cooking chamber communicate with each other, and
a tubular portion extending from the communication hole toward the outside of the heating cooking chamber,
the metal member is disposed between the glass plate and the light source substrate, and
a size of the communication hole of the metal member is smaller than a size of the communication hole of the first inclined wall.

5. The heating cooking apparatus according to claim 4,
wherein the attachment member includes
a plurality of wall portions made of metal, and
a metal plate disposed between the plurality of wall portions and including a through hole,
the metal member further includes a metal plate in which the communication hole of the metal member is located,
the metal plate of the metal member faces the metal plate of the attachment member, and
the tubular portion of the first inclined wall passes through the through hole of the attachment member and is surrounded by the metal member and the attachment member except for a portion corresponding to the communication hole of the metal member.

6. The heating cooking apparatus according to claim 1, further comprising:
a second recessed portion located in a second wall of the plurality of walls and recessed from the second wall; and
a second light source unit disposed in the second recessed portion,
wherein the second wall and the first wall face each other,
the second recessed portion includes a second inclined wall inclined with respect to the second wall,
the second light source unit is disposed on the second inclined wall, and
the second light source unit emits light toward the back wall of the heating cooking chamber.
